(19) United States
(12) Patent Application Publication
(10) Pub. No.: US 2024/0348293 A1
(43) Pub. Date: Oct. 17, 2024

(54) BEAM FORMAT DETECTION IN HOLOGRAPHIC MIMO SYSTEMS

(71) Applicant: QUALCOMM Incorporated, San Diego, CA (US)

(72) Inventors: Danlu ZHANG, San Diego, CA (US); Yu ZHANG, San Diego, CA (US); Peter GAAL, San Diego, CA (US); Min HUANG, Beijing (CN); Wei XI, Beijing (CN); Chao WEI, Beijing (CN); Hao XU, Beijing (CN); Vasanthan RAGHAVAN, West Windsor Township, NJ (US); Junyi LI, Fairless Hills, PA (US)

(21) Appl. No.: 18/291,709

(22) PCT Filed: Sep. 29, 2021
(86) PCT No.: PCT/CN2021/121644

§ 371 Date: Jan. 24, 2024

(51) Int. Cl. H04B 7/0413; H04B 7/06

(52) U.S. Cl. CPC H04B 7/0413; H04B 7/0695

(57) ABSTRACT

Various aspects of the present disclosure generally relate to wireless communication. In some aspects, a receiver of a holographic multiple input multiple output (MIMO) communication may receive, using at least one receive antenna element, a plurality of reference signals associated with at least one transmit antenna element of a transmitter of the holographic MIMO communication. The receiver may communicate using two-dimensional beams or three-dimensional beams based at least in part on a determination of a beam format associated with the plurality of reference signals. Numerous other aspects are described.

### FIELD OF THE DISCLOSURE

Aspects of the present disclosure generally relate to wireless communication and to techniques and apparatuses for beam format detection in holographic multiple input multiple output systems.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a receiver of a holographic multiple input multiple output (MIMO) communication. The method may include receiving, using at least one receive antenna element, a plurality of reference signals associated with at least one transmit antenna element of a transmitter of the holographic MIMO communication. The method may include communicating using two-dimensional beams or three-dimensional beams based at least in part on a determination of a beam format associated with the plurality of reference signals.

Some aspects described herein relate to a method of wireless communication performed by a transmitter of a holographic MIMO communication. The method may include transmitting, to a receiver of the holographic MIMO communication that includes at least one receive antenna element, a plurality of reference signals associated with at least one transmit antenna element of the transmitter. The method may include receiving a feedback indication based at least in part on a determination of a beam format associated with the plurality of reference signals.

Some aspects described herein relate to a receiver of a holographic MIMO communication. The receiver of a holographic MIMO communication may include a memory and one or more processors coupled to the memory. The one or more processors may be configured to receive, using at least one receive antenna element, a plurality of reference signals associated with at least one transmit antenna element of a transmitter of the holographic MIMO communication. The one or more processors may be configured to communicate using two-dimensional beams or three-dimensional beams based at least in part on a determination of a beam format associated with the plurality of reference signals.

Some aspects described herein relate to a transmitter of a holographic MIMO communication. The transmitter of a holographic MIMO communication may include a memory and one or more processors coupled to the memory. The one or more processors may be configured to transmit, to a receiver of the holographic MIMO communication that includes at least one receive antenna element, a plurality of reference signals associated with at least one transmit antenna element of the transmitter. The one or more processors may be configured to receive a feedback indication based at least in part on a determination of a beam format associated with the plurality of reference signals.

Some aspects described herein relate to a non-transitory computer-readable medium that stores a set of instructions for wireless communication by a receiver of a holographic MIMO communication. The set of instructions, when executed by one or more processors of the receiver, may cause the receiver to receive, using at least one receive antenna element, a plurality of reference signals associated with at least one transmit antenna element of a transmitter of the holographic MIMO communication. The set of instructions, when executed by one or more processors of the receiver, may cause the receiver to communicate using two-dimensional beams or three-dimensional beams based at least in part on a determination of a beam format associated with the plurality of reference signals.

Some aspects described herein relate to a non-transitory computer-readable medium that stores a set of instructions for wireless communication by a transmitter of a holographic MIMO communication. The set of instructions, when executed by one or more processors of the transmitter, may cause the transmitter to transmit, to a receiver of the holographic MIMO communication that includes at least one receive antenna element, a plurality of reference signals associated with at least one transmit antenna element of the transmitter. The set of instructions, when executed by one or more processors of the transmitter, may cause the transmitter to receive a feedback indication based at least in part on a determination of a beam format associated with the plurality of reference signals.

Some aspects described herein relate to an apparatus for receiving a holographic MIMO communication. The apparatus may include means for receiving, using at least one receive antenna element, a plurality of reference signals associated with at least one transmit antenna element of a transmitter of the holographic MIMO communication. The apparatus may include means for communicating using two-dimensional beams or three-dimensional beams based at least in part on a determination of a beam format associated with the plurality of reference signals.

Some aspects described herein relate to an apparatus for transmitting a holographic MIMO communication. The apparatus may include means for transmitting, to a receiver of the holographic MIMO communication that includes at least one receive antenna element, a plurality of reference signals associated with at least one transmit antenna element of the apparatus. The apparatus may include means for receiving a feedback indication based at least in part on a determination of a beam format associated with the plurality of reference signals.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of beam management, in accordance with the present disclosure.

FIG. 4 is a diagram illustrating examples of holographic multiple input multiple output (MIMO) systems, in accordance with the present disclosure.

FIGS. 5-7 are diagrams illustrating examples associated with beam format detection in holographic MIMO systems, in accordance with the present disclosure.

FIGS. 8 and 9 are diagrams illustrating example processes associated with beam format detection in holographic MIMO systems, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

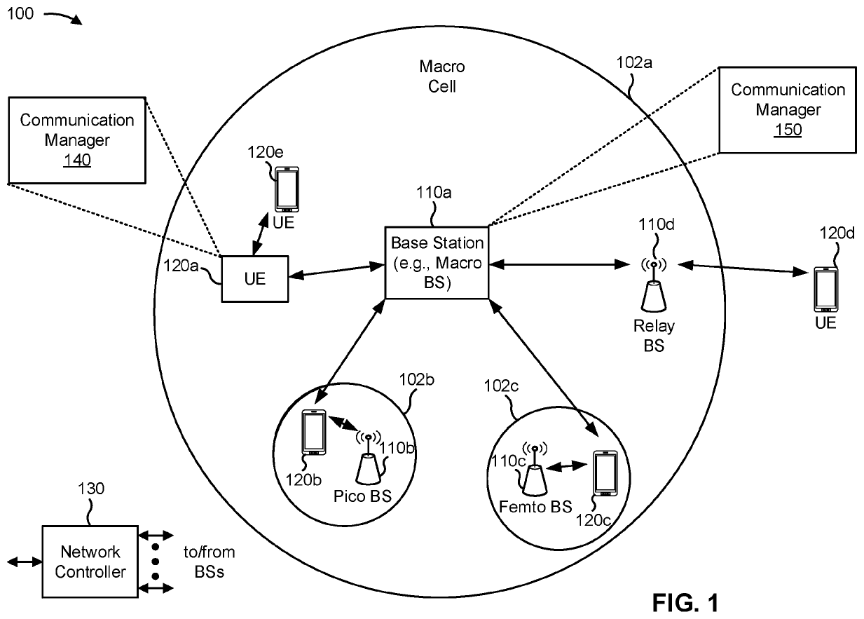

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 ar often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the receiver may include a communication manager 140 or 150. As described in more detail elsewhere herein, the communication manager 140 or 150 may receive, using at least one receive antenna element, a plurality of reference signals associated with at least one transmit antenna element of a transmitter of the holographic MIMO communication; and communicate using two-dimensional beams or three-dimensional beams based at least in part on a determination of abeam format associated with the plurality of reference signals. Additionally, or alternatively, the communication manager 140 or 150 may perform one or more other operations described herein.

In some aspects, the transmitter may include a communication manager 140 or 150. As described in more detail elsewhere herein, the communication manager 140 or 150 may transmit, to a receiver of the holographic MIMO communication that includes at least one receive antenna element, a plurality of reference signals associated with at least one transmit antenna element of the transmitter; and receive a feedback indication based at least in part on a determination of a beam format associated with the plurality of reference signals. Additionally, or alternatively, the communication manager 140 or 150 may perform one or more other operations described herein.

As indicated above, FIG. 1 is provided as an example. Other examples may differ from what is described with regard to FIG. 1.

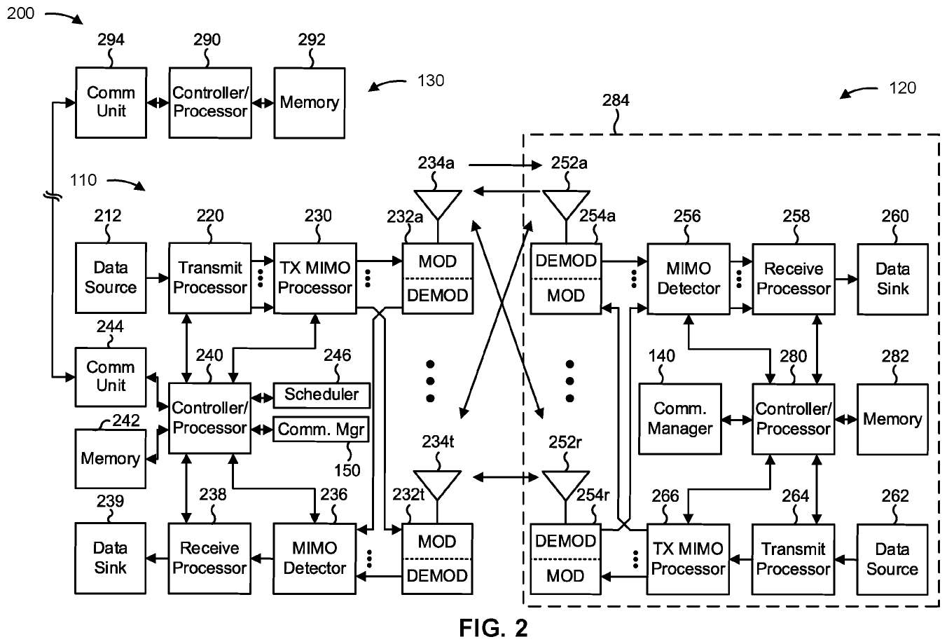

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication is an indication of a beam. A beam indication may be, or include, a TCI state information element, a beam identifier (ID), spatial relation information, a TCI state ID, a close loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellfndex), a bandwidth part identification (bwp-Id), a reference signal identification such as a CSI-RS (e.g., anNZP-CSI-RS-Resourceld, an SSB-Index, and/or the like), and/or the like. Spatial relation information may similarly indicate information associated with an uplink beam.

The beam indication may be a joint or separate downlink (DL)/uplink (UL) beam indication in a unified transmission configuration indicator (TCI) framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Some UEs and/or base stations may support full duplex operation in which the UEs and/or the base stations support full duplex operations. For example, a UE may support transmission via a first beam (e.g., using a first antenna panel) and may simultaneously support reception via a second beam (e.g., using a second antenna panel). Support for simultaneous transmission and reception may be conditional on beam separation, such as spatial separation (e.g., using different beams), frequency separation, and/or the like. Additionally, or alternatively, support for simultaneous transmission may be conditional on using beamforming (e.g., in frequency range 2 (FR2), in frequency range 4 (FR4), for millimeter wave signals, and/or the like).

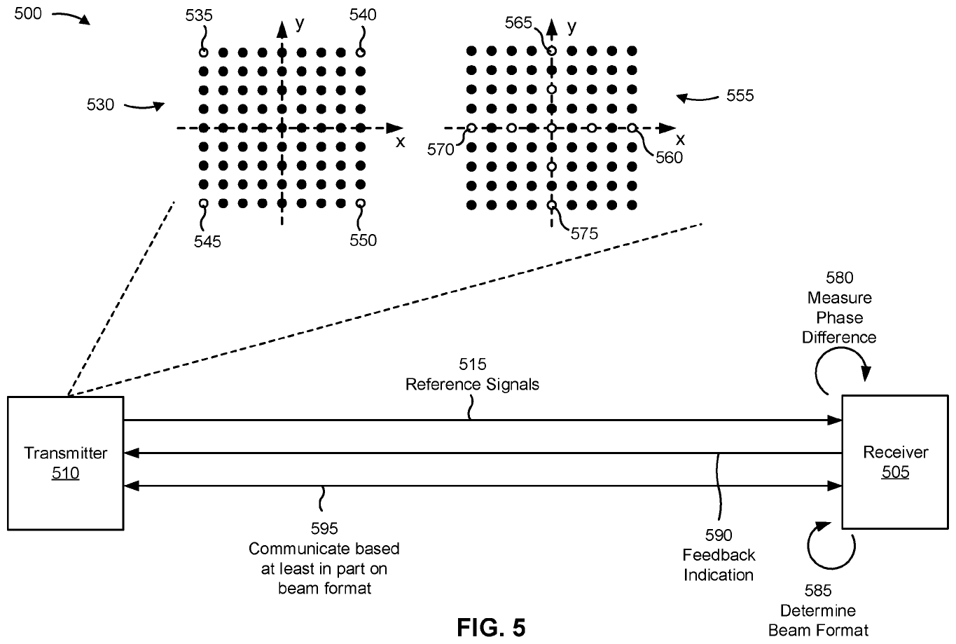

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

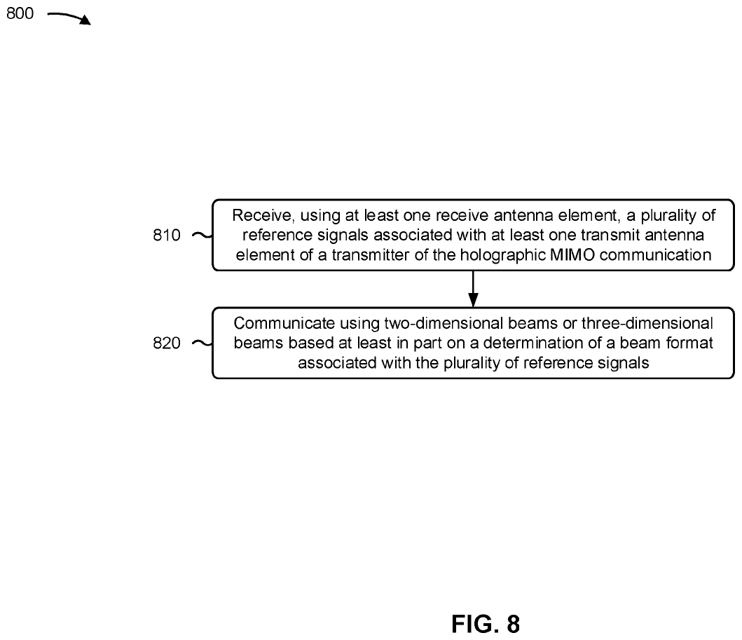

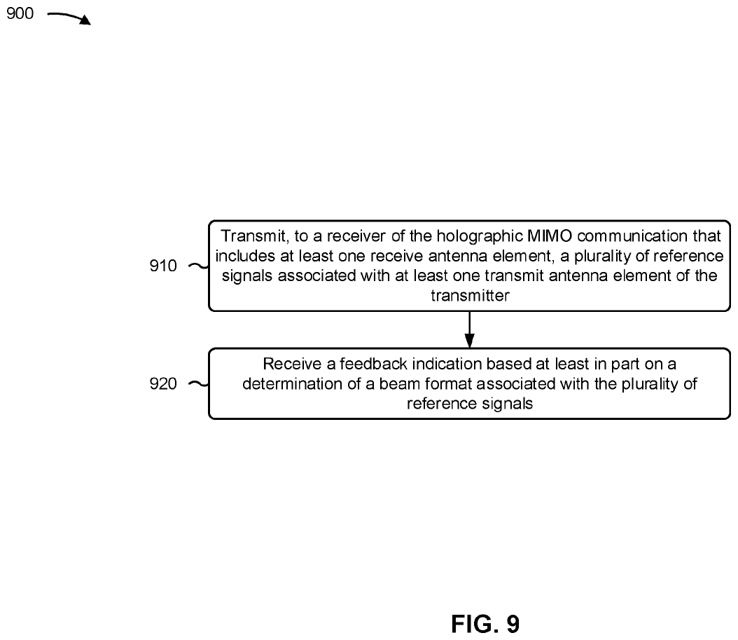

The controller/processor 240 of the base station 110, the controller/processor 280 of the UE 120, and/or any other component(s) of FIG. 2 may perform one or more techniques associated with beam format detection in holographic MIMO systems, as described in more detail elsewhere herein. In some aspects, the receiver described herein is the base station 110, is included in the base station 110, or includes one or more components of the base station 110 shown in FIG. 2. In some aspects, the receiver described herein is the UE 120, is included in the UE 120, or includes one or more components of the UE 120 shown in FIG. 2. In some aspects, the transmitter described herein is the base station 110, is included in the base station 110, or includes one or more components of the base station 110 shown in FIG. 2. In some aspects, the transmitter described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the receiver includes means for receiving, using at least one receive antenna element, a plurality of reference signals associated with at least one transmit antenna element of a transmitter of the holographic MIMO communication; and/or means for communicating using two-dimensional beams or three-dimensional beams based at least in part on a determination of a beam format associated with the plurality of reference signals. In some aspects, the means for the receiver to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the receiver to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the transmitter includes means for transmitting, to a receiver of the holographic MIMO communication that includes at least one receive antenna element, a plurality of reference signals associated with at least one transmit antenna element of the transmitter; and/or means for receiving a feedback indication based at least in part on a determination of a beam format associated with the plurality of reference signals. In some aspects, the means for the transmitter to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitter to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

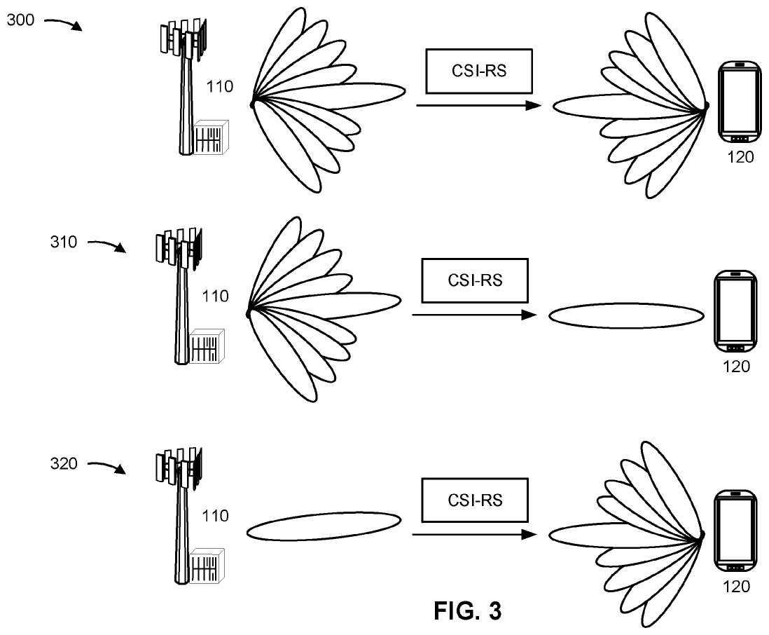

FIG. 3 is a diagram illustrating examples 300, 310, and 320 of channel state information (CSI)-reference signal (RS) beam management procedumes, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 3, example 300 may include a base station 110 and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use synchronization signal blocks (SSBs) for beam management in a similar manner as described above.

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

The base station 110 and the UE 120 can perform two-dimensional (2D) beamforming using antenna arrays. 2D beamforming can concentrate transmission power to a direction, described by angles in azimuth and zenith (e.g., angle-of-departure (AoD), angle-of-arrival (AoA), zenith-of-departure (ZoD), and zenith-of-arrival (ZoA)). However, 2D beamforming can have some disadvantages such as, for example, reduced opportunities for multi-user (MU)-MIMO. For example, 2D beamforming generally cannot be used to distinguish UEs that are oriented in a same direction but located at different distances from the base station, and thus cannot pair such UEs for MU-MIMO transmission. As a result, 2D beamforming can result in restricted MU pairing opportunities, restricted MU diversity gain, and reduced cell-level spectral efficiency. 2D beamforming also can lead to low transmission power utilization efficiency. For example, a 2D beam covers an entire area of a certain angle, but the target UE is located only at one spot with a certain distance from the base station. Thus, the transmission power used to transmit aspects of the signal landing in areas with other distances from the base station is wasted.

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

In some cases, three-dimensional (3D) beamforming can be used to overcome one or more of the disadvantageous of 2D beamforming. For example, when a distance of a coverage area is sufficiently short (e.g., relative to a panel size of a transmission panel), the generated beam to the coverage area can have holographic characteristics. Such a beam can be capable of facilitating distinguishing direction and distance and, as a result, can be referred to as a 3D beam or holographic beam. Equivalently, the energy in the transmitted beam can be concentrated to a single point out of multiple specific points of choice in space. In this way, a 3D beam can cover a certain angular range and a certain distance range.

3D beams can be beamformed using 3D beamforming. 3D beamforming can be used, for example, to support high MU-MIMO opportunities. A holographic MIMO system is a system in which one or more 3D beams are used to transmit one or multiple data streams. 3D beamforming can facilitate distinguishing between UEs with the same direction and different distances and, as a result, can be used to pair the UEs for MU-MIMO communication. As a result, 3D beamforming can facilitate enhanced MU pairing opportunity, MU diversity gain, and improved cell-level spectral efficiency. Additionally, because a 3D beam covers an area of a target UE in terms of both direction and distance, 3D beamforming can facilitate minimizing transmission power associated with signals landing at other areas, thereby increasing transmission power utilization efficiency.

Holographic MIMO can be accomplished using a large array of controlled transmitters and receivers. Due in part to the large number of antenna elements in the antenna panel, holographic MIMO technology can be used at high frequency spectrum (e.g., frequency range 2 (FR2) in NR), or even higher frequency spectrums (e.g., sub-terahertz and/or terahertz spectrums). At these high frequency spectrums, the beamforming mode is generally analog beamforming or hybrid beamforming and, thus, beam sweeping quality and latency can have a significant impact on system performance. In some cases, transmitters and/or receivers of a holographic MIMO system can generate both 2D and 3D beams.

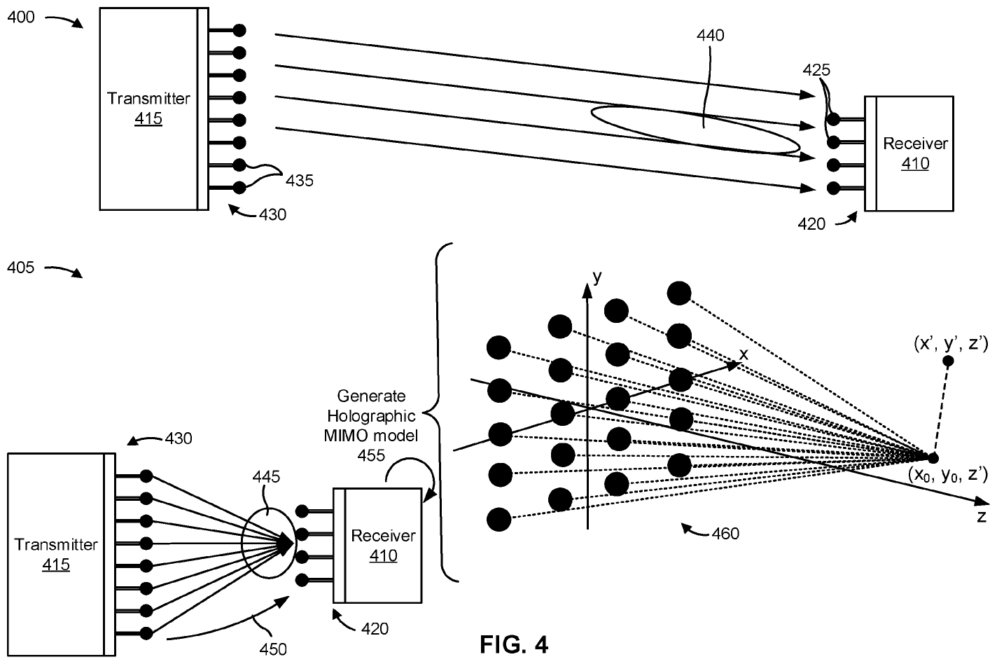

FIG. 4 is a diagram illustrating examples 400 and 405 of beam formats, in accordance with the present disclosure. As shown in FIG. 4, examples 400 and 405 include a receiver 410 of holographic MIMO communications in communication with a transmitter 415 of holographic MIMO communications in a wireless network (e.g., wireless network 100). The devices shown in FIG. 4 are provided as examples, and the receiver 410 and/or the transmitter 410 may be, include, or be included in one or morn UEs, one or more base stations, one or more transmit receive points (TRPs), one or more mobile termination nodes, one or more control nodes, and/or one or more integrated access and backhaul (IAB) nodes, among other examples. The receiver 410 may include a receive antenna panel 420 having a plurality of receive antenna elements 425 and the transmitter 415 may include a transmit antenna panel 430 having a plurality of transmit antenna elements 435.

Example 400 illustrates an example of 2D beamforming and example 405 illustrates an example of 3D beamforming. In example 400, the receiver 410 may be located in a far field with respect to the transmitter 415. In the far field, the receiver 410 may receive a communication transmitted by the transmitter 415 using a discrete Fourier transform (DFT)-based receive beam 440. In example 405, the receiver 410 may be located within a near field with respect to the transmitter 415. In the near field, the receiver 410 may receive a communication transmitted by the transmitter 415 using a non-DFT-based receive beam 445. In some cases, the partitioning distance of near field (further divided as reactive near field and radiating near field) and far field depends on the antenna panel size (D) and the wavelength (λ) of the signal carrying the communication. For example, a reactive near field may correspond to a distance from the transmitter 415 that is between 0 and 0.62 \sqrt{D³/λ}, inclusive, a radiating near field may correspond to a distance in the range of 0.62 \sqrt{D³/λ} to 2D²/λ, and a far field may correspond to a distance in the range of 2D²/λ to infinity (∞). In some cases, a radiating near field may be equivalent to a Fresnel diffraction zone.

Suitable downlink receive beam weights and/or uplink transmit beam weights for far-field (2D) beams can be different than suitable beam weights for near-field (3D) beams. For example, in some cases, the transmitter 415 and the receiver 410 may both use uniform linear array (ULA) antennas or uniform planar army (UPA) antennas. When the receiver 410 is located in the far-field of the transmit antenna panel 430, the size of the transmit antenna panel 430 can be ignored when analyzing the transmitted communication, so the arrived signals at the receiver 410 can be approximated as a planar wave (e.g., the channel gains of antenna elements 435 in the panel 430 have linear-increased phases and quasi-identical amplitudes). In this case, the set of suitable beam weights for the transmitter 415 and the receiver 410 may be the DFT coefficients.

When the receiver 410 is located in the near-field of the transmit antenna panel 430, the size of the transmit antenna panel 430 shouldn't be ignored when analyzing the communication, so the arrived signals at the receiver 410 cannot be approximated as planar wave. In this case, the suitable beam weights for the transmitter 415 and the receiver 410 are no longer the DFT coefficients. Another set of suitable beamforming weights (non-DFT-based) can be used (e.g., quadratic terms that are present in the phase component). Because of the different characteristics of near field and far field, wireless communication devices can adopt different sets of beams to transmit or receive using these two kinds of beam formats. However, if a receiving device is not aware of the beam format being used, the receiving device can receive communications using a beam format that is different than the beam format being used to transmit the communications and/or that is otherwise inappropriate for the communications. Although a device can sweep both types of beams, doing so increases beam determination latency. As a result, using more than one optional beam format can introduce inaccuracies and inefficiencies in the communication, thereby having a negative impact on network and/or device performance.

Some aspects of the techniques and apparatuses described herein provide for determining a beam format that is being used so that communications may be transmitted and/or received in an accurate and efficient manner. For example, as shown by reference number 450, the transmitter 415 may transmit a plurality of reference signals to the receiver 410. As shown by reference number 455, the receiver 410 may generate a holographic MIMO model 460 corresponding to the received reference signals and may use that model 460 to determine whether the received beam is a 2D beam or a 3D beam. The receiver 410 also may determine, based at least in part on the reference signals, whether the receiver 410 is located in a far field or a near field with respect to the transmitter 415. In this way, aspects may facilitate determining beam formats and adjusting communication parameters appropriately, thus introducing accuracies and efficiencies in the communication, and thereby positively impacting the network and/or device performance.

In some aspects, based on the theory of Green's function (signal from a single point source with the same boundary condition), under par-axial approximation, Maxwell/Helmholtz equations like ∇²v+k²v=0 can be solved in an integral form, which is equivalent to the Huygens-Fresnel principle. The signal at receiver plane v can be written as a function of transmitter signal u as

$$v = \int \int u \frac{exp ( jkr )}{r} ψ d S$$

where ψ=cos θ or some other function of the angle of propagation close to cos θ. In the current problem, ψ≈1. This integral form can be solved using simulation.

In the holographic MIMO model 460, the transmitter panel is located at z=0. If the transmitter array 430 has a phase profile, that phase profile may be used to study an arbitrary receiver at (x′, y′, z′). In some cases, the beamforming may target a spherical waveform converging to a single point (x₀, y₀, z′), which is a 3D waveform. Applying reverse propagation, the transmitter array 430 has a phase profile of

$$exp [ - \frac{i 2 π r}{λ} ] ,$$

with r=\sqrt{z′²+(x−x₀)²+(y−y₀)²}. Defining r₀=\sqrt{z′²+x₀²+y₀²} facilitates approximating the above phase term by the following, based on par-axial condition

$$\frac{{( x {x}_{0} )}^{2}}{λ {r}^{3}} ≪ 1 , \frac{{( {yy}_{0} )}^{2}}{λ {r}^{3}} ≪ 1 , \frac{{x}^{4}}{λ {r}^{3}} ≪ 1 , \frac{{y}^{4}}{λ {r}^{3}} ≪ 1 , \frac{{x}_{0}^{4}}{λ {r}^{3}} ≪ 1 , \frac{{y}_{0}^{4}}{λ {r}^{3}} ≪ 1 ,$$

$$where$$

$$exp [ - \frac{i 2 π r}{λ} ] ∼ exp [ - \frac{i π [ {( x - {x}_{0} )}^{2} + {( y - {y}_{0} )}^{2} ]}{λ {r}_{0}} ] ∼ exp [ - \frac{i π ( {x}^{2} + {y}^{2} )}{λ {r}_{0}} ] exp [ \frac{i 2 π ( x {x}_{0} + y {y}_{0} )}{λ {r}_{0}} ] .$$

For 3D waves,

$$exp [ - \frac{i 2 π r}{λ} ] ∼ exp [ - \frac{i π [ {( x - {x}_{0} )}^{2} + {( y - {y}_{0} )}^{2} ]}{λ {r}_{0}} ] .$$

The waveform with the quadric phase term

$$exp [ - \frac{i π ( {x}^{2} + {y}^{2} )}{λ {r}_{0}} ]$$

is a characteristic of 3D waveforms (or “near-field”). If

$$\frac{( {x}^{2} + {y}^{2} )}{λ {r}_{0}} ≪ 1 ,$$

the rx is in far-field, the above quadratic phase term can be ignored. In a far-field situation, x₀/r₀ may not be negligible because it represents a departure angle. Therefore, if the following sines and cosines are defined as

$$sin {θ}_{0 , x} = \frac{{x}_{0}}{{r}_{0}} and sin {θ}_{0 , y} = \frac{{y}_{0}}{{r}_{0}} ,$$

the 2-D (far-field) waveform has a phase term of

$$exp [ - \frac{i 2 π r}{λ} ] ∼ exp [ \frac{i 2 π ( {xx}_{0} + {yy}_{0} )}{λ {r}_{0}} ] = exp [ \frac{i 2 π}{λ} ( x sin {θ}_{0 , x} + y sin {θ}_{0 , y} ) ] .$$

The far-field analysis may be alternatively represented using an angular spread function. For example, if

$$\frac{{x}^{2}}{λ z ′} ≪ 1 , \frac{{y}^{2}}{λ z ′} ≪ 1 ,$$

the receiving antenna panel 425 is located in the far field with respect to the transmitter 415, and the transmit antenna panel 430 may have a phase term:

$$exp [ \frac{i 2 π}{λ} ( x sin {θ}_{0 , x} + y sin {θ}_{0 , y} ) ] .$$

The quadratic term in propagation

$$exp [ - \frac{i π ( {x}^{2} + {y}^{2} )}{λ {r}_{0}} ]$$

is negligible in far field, so the results obtained above using the method described there apply.

As indicated above, FIG. 4 is provided as an example. Other examples may differ from what is described with regard to FIG. 4.

FIG. 5 is a diagram illustrating an example 500 of beam format detection in holographic MIMO systems, in accordance with the present disclosure. As shown in FIG. 5, a receiver 505 and a transmitter 510 may communicate with one another. The receiver 505 may be, or be similar to, the receiver 410 shown in FIG. 4 and the transmitter 510 may be, or be similar to, the transmitter 415 shown in FIG. 4. The receiver 505 may be a receiver of a holographic MIMO communication and the transmitter 510 may be a transmitter of the holographic MIMO communication.

As shown by reference number 515, the transmitter 510 may transmit, and the receiver 505 may receive, a plurality of reference signals. The reference signals may be received using at least one receive antenna element of a receive antenna panel associated with the receiver 505. The reference signals may be associated with at least one transmit antenna element of the transmitter 510. In some aspects, the plurality of reference signals may be generated from a common phase reference source.

In some aspects, the at least one receive antenna element may include only a single receive antenna element and the at least one transmit antenna element may include a plurality of transmit antenna elements. In other aspects, the at least one receive element may include a plurality of receive antenna elements and the at least one transmit antenna element may include only a single transmit antenna.

In cases in which multiple transmit antenna elements transmit to one receive antenna element, the plurality of transmit antenna elements may include a first transmit antenna element associated with a first axis of a reference coordinate system corresponding to a transmit antenna panel and a second transmit antenna element associated with a second axis of the reference coordinate system. The first and second axes may be perpendicular to one another and correspond to a plane in which the transmit antenna panel lies. For example, a transmitter antenna panel may be arranged in a grid pattern corresponding to an x-axis and a perpendicular y-axis.

FIG. 5 includes a schematic diagram 530 of a transmit antenna panel structure, in which the circles represent transmit antenna elements. As shown, the transmit antenna elements lie in a plane corresponding to a coordinate system having an x-axis and a y-axis. To facilitate transmitting reference signals that can be used by the receiver 505 to determine beam format, a subset of the transmit antenna elements having specified positions in the array may be used. In some aspects, the transmit antenna elements to be used may be subject to higher maximum power limitations than the other elements in the array. For example, the plurality of transmit antenna elements each may be associated with a first maximum transmit power, and at least one unused transmit antenna element may be associated with a second maximum transmit power that is different (e.g., lower) than the first maximum transmit power.

For example, in some aspects, as shown by reference number 530, four transmit antenna elements (indicated by open circles) may be used to transmit reference signals. For example, the transmit antenna elements to be used may include a first transmit antenna element 535 located at a first corner of the transmit antenna panel. A second transmit antenna element 540 may be located at a second corner of the transmit antenna panel, a third transmit antenna element 545 may be located at a third corner of the transmit antenna panel, and a fourth transmit antenna element 550 may be located at a fourth corner of the transmit antenna panel.

In another example, each of the transmit antenna elements to be used to transmit the reference signals may be located on one of the two axes. FIG. 5 includes another schematic diagram 555 of another transmit antenna panel structure, in which the circles represent transmit antenna elements. As shown, the transmit antenna elements lie in a plane corresponding to a coordinate system having an x-axis and a y-axis and transmit antenna elements to be used to transmit reference signals are again indicated by open circles. A first transmit antenna element 560 to be used to transmit reference signals may be located on a first axis (x-axis) of the reference coordinate system. A second transmit antenna element 565 to be used to transmit reference signals may be located on the second axis (y-axis) of the reference coordinate system. As shown, a third transmit antenna element 570 to be used to transmit reference signals may be located on the x-axis and a fourth transmit antenna element 575 to be used to transmit reference signals may be located on the y-axis. As shown in FIG. 5, additional transmit antenna elements to be used to transmit reference signals may be located on the x-axis and/or the y-axis. In some aspects, an antenna element to be used to transmit reference signals may be located at the origin of the reference system (the intersection of the x-axis and the y-axis).

Arranging the antenna elements to be used to transmit reference signals symmetrically may assist in the predictability of phase differences between reference signals and, therefore, facilitate determination, by the receiver 505, of the beam format. In some aspects, each of the plurality of transmit antenna elements (or at least the transmit antenna elements to be used to transmit reference signals) may be individually identifiable to the receiver. For example, each of the plurality of transmit antenna elements may correspond to a respective cyclic shift of a sequence used to generate a respective reference signal of the plurality of reference signals. The time-frequency resources for the reference signal from each of the plurality of transmit antenna elements may have a pre-defined pattern. Phase noise may cause the relative phase in the transmitted reference signal from each of the plurality of transmit antenna elements to vary randomly with time. Therefore, the time for transmitting each reference signal from each of the plurality of transmit antenna elements should be scheduled close enough to one another to overcome the possible de-correlation from the phase noise. In some aspects, each reference signal may be sufficiently dense in the frequency domain so as to mitigate and/or eliminate phase ambiguity. For example, each reference signal may include a frequency domain density that satisfies a density threshold.

For example, for removing phase ambiguity of multiples of 27 or distance ambiguity of multiple wavelengths, the reference signals may be configured to sample the frequency domain with a density on the order of 10² kilohertz (kHz). In some aspects, the receiver 505 may use multiple sub-carriers in the reference signal to remove phase ambiguity. In some aspects, the receiver 505 may remove ambiguity in an estimated differential phase or differential distance such as d₁−d₂, although d₁ and d₂ themselves may still have ambiguity.

If the density of the reference signals is not sufficient to remove phase ambiguity, the density of transmit antenna elements and/or receive antenna elements within the respective antenna panels may be sufficient to mitigate the phase ambiguity. For example, in some aspects, each antenna element may be spaced apart from each immediately adjacent antenna element by a distance equal to less than half of a wavelength of each reference signal. In some aspects, each reference signal may span an entire available bandwidth to improve the accuracy of phase differential measurement.

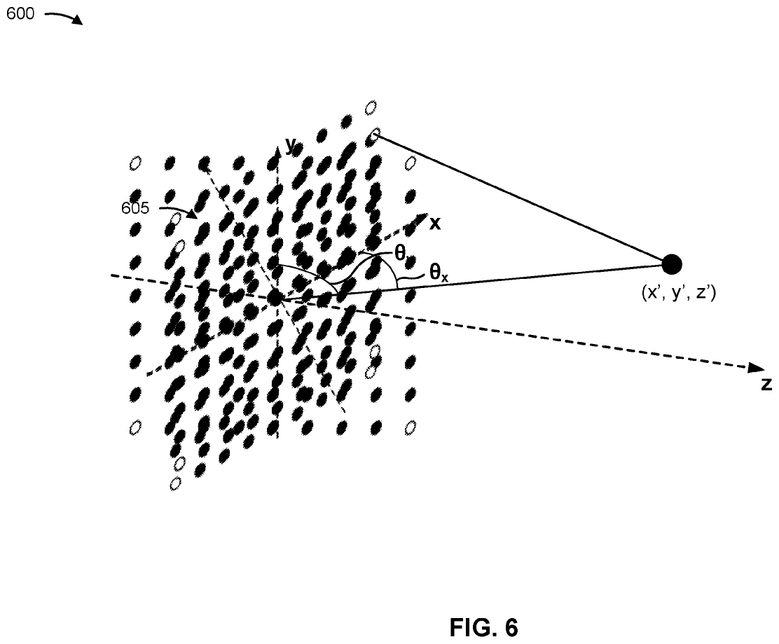

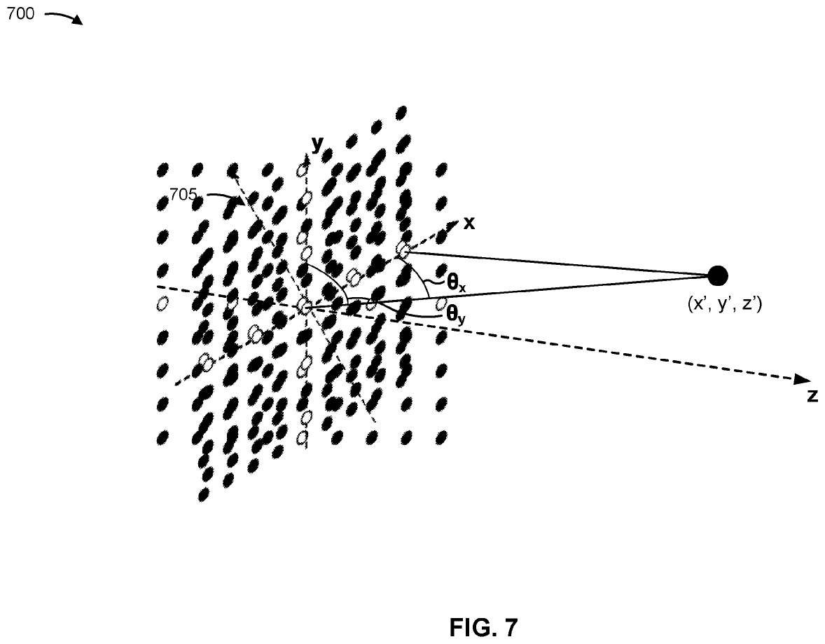

As shown by reference number 580, the receiver 505 may measure a phase difference across the plurality of transmit antenna elements and as shown by reference number 585, the receiver 505 may determine the beam format based at least in part on the phase difference. In some aspects, as explained in more detail below in connection with FIGS. 6 and 7, the receiver 505 may determine the beam format based at least in part on at least one of a quadratic expansion procedure, a Taylor expansion procedure, or a regression-type estimation procedure.

In some aspects, as indicated above, the at least one receive antenna element may include a plurality of receive antenna elements, and the at least one transmit antenna element may include only a single transmit antenna element. In that case, the receiver 505 may measure the phase difference across the plurality of receive antenna elements and determine the beam format based at least in part on that phase difference.

In some aspects, the plurality of receive antenna elements may be arranged as described above in connection with reference numbers 530 and 555 in regard to the transmit antenna elements. For example, a first receive antenna element may be associated with a first axis of a reference coordinate system corresponding to a receive antenna panel and a second receive antenna element may be associated with a second, perpendicular, axis of the reference coordinate system. The perpendicular axes may correspond to a plane in which the receive antenna panel lies.

Similarly to the transmit antenna panel described above, in some aspects, the receive antenna panel may include a first receive antenna element located at a first corner of the receive antenna panel, a second receive antenna element located at a second corner of the receive antenna panel, a third receive antenna element located at a third corner of the receive antenna panel, and a fourth receive antenna element located at a fourth corner of the receive antenna panel. In some aspects, a first receive antenna element may be located on the first axis of the reference coordinate system and a second receive antenna element may be located on the second axis of the reference coordinate system. In some aspects, the plurality of receive antennas may use a common phase reference source.

As shown by reference number 590, the receiver 505 may transmit, and the transmitter 510 may receive, a feedback indication. In some aspects, the receiver 505 may transmit the feedback indication by transmitting at least one of a radio resource control (RRC) message, a medium access control control element (MAC CE), or a physical layer signal. In some aspects, the feedback indication may indicate at least one of a plurality of carrier phase measurements corresponding to the plurality of reference signals or a position measurement parameter corresponding to the receiver with respect to an antenna panel of the transmitter. In some aspects, the feedback indication may include an accuracy indication associated with the position measurement parameter.

As shown by reference number 595, the receiver 505 and the transmitter 510 may communicate based at least in part on the beam format. For example, the transmitter 510 may transmit a holographic MIMO communication to the receiver 505 using a transmit beam of a first beam format (e.g., a 3D beam) and the receiver 505 may receive the holographic MIMO communication using a receive beam of the first beam format.

As indicated above, FIG. 5 is provided as an example. Other examples may differ from what is described with respect to FIG. 5. For example, in some aspects, the receiver 505 may determine whether the receiver 505 is within a far-field region with respect to the transmitter 510 based at least in part on one or more phase difference measurements associated with the plurality of reference signals. In some aspects, the receiver 505 may determine the beam format during a positioning procedure.

FIG. 6 is a diagram illustrating an example 600 of a holographic MIMO model used for beam format detection in holographic MIMO systems, in accordance with the present disclosure. As shown in FIG. 6, a transmit antenna panel 605 may include a number of transmit antenna elements, shown as circles. The transmit antenna panel 605 may include a subset of transmit antenna panel elements (shown as open circles) to be used to transmit reference signals. The transmit antenna panel 605 may be, or be similar to, a transmit antenna panel of the transmitter 510 shown in FIG. 5 and/or the transmitter 415 shown in FIG. 4. Although the description below describes operations of a receiver having (or using) a single antenna element (represented by the circle at coordinate (x′, y′, z′) and which may be, or be similar to, the receiver 505 shown in FIG. 5 and/or the receiver 410 shown in FIG. 4), the concepts described below may alternatively and similarly apply to operations of a receiver having (or using) a plurality of antenna elements receiving reference signals transmitted by a single transmit antenna elements.

As described above, the receiver may determine a beam format based at least in part on determination of a phase difference measurement. Determining the phase distance measurement may include determination of position (x′, y′, z′) or angles (θₓ, θ_{y}). For example, in some aspects, a total phase of RS from

$$( \frac{{D}_{x}}{2} , \frac{{D}_{y}}{2} , 0 )$$

at a first sub-carrier f1 may be given by

$$\frac{2 π {f}_{1} {d}_{1}}{c} = {φ}_{1} ( {f}_{1} ) + {m}_{1 , {f}_{1}} ( 2 π ) ,$$

and a total phase of RS from

$$( - \frac{{D}_{x}}{2} , \frac{{D}_{y}}{2} , 0 )$$

at the sub-carrier f1 may be given by

$$\frac{2 π {f}_{1} {d}_{2}}{c} = {φ}_{2} ( {f}_{1} ) + {m}_{2 , {f}_{1}} ( 2 π ) ,$$

$$where$$

$${φ}_{1} ( {f}_{1} ) - {φ}_{2} ( {f}_{1} ) + ( {m}_{1 , {f}_{1}} - {m}_{2 , {f}_{1}} ) ( 2 π ) = \frac{2 π {f}_{1}}{c} ( {d}_{1} - {d}_{2} ) ,$$

$$and$$

$${φ}_{1} ( {f}_{2} ) - {φ}_{2} ( {f}_{2} ) + ( {m}_{1 , {f}_{2}} - {m}_{2 , {f}_{2}} ) ( 2 π ) = \frac{2 π {f}_{2}}{c} ( {d}_{1} - {d}_{2} ) .$$

In some aspects, φ₁(f₁), φ₂(f₁), φ₁(f₂), φ₂ (f₂) may be observable by channel estimation based on the reference signal, but the unknown integer multiple of 2π may be resolved by the receiver. For example, if a multiple of 2π remains in [φ₁(f₁)−φ₂(f₁)]−[φ₁(f₂)−φ₂(f₂)], namely, (m_{1,f}_{₁}−m_{2,f}_{₁})≠(m_{1,f}_{₂}−m_{2,f}_{₂}), this indicates that |2π/c(f₁−f₂)(d₁−d₂)|≥2π, which implies

$$\vert ( {d}_{1} - {d}_{2} ) \vert \geq \frac{c}{\vert {f}_{1} - {f}_{2} \vert} .$$

In some aspects, reference signals may be placed densely in the frequency domain. For example, |f₁−f₂| may be on the order of sub-carrier spacing and/or physical resource block size. Accordingly, in some aspects, |f₁−f₂|˜10² kHz, and the corresponding ambiguity length |(d₁−d₂)|˜10³ m, which may be sufficient for phase ambiguity mitigation.

In some aspects, the receiver may perform phase measurement processing to determine, for example, the following distances:

$$a distance from ( \frac{{D}_{x}}{2} , \frac{{D}_{y}}{2} , 0 ) = {d}_{1} = \sqrt{{z}^{′2} + {( {x}^{′} - \frac{{D}_{x}}{2} )}^{2} + {( {y}^{′} - \frac{{D}_{y}}{2} )}^{2}} ,$$

$$a distance from ( - \frac{{D}_{x}}{2} , \frac{{D}_{y}}{2} , 0 ) = {d}_{2} = \sqrt{{z}^{′2} + {( {x}^{′} + \frac{{D}_{x}}{2} )}^{2} + {( {y}^{′} - \frac{{D}_{y}}{2} )}^{2}} ,$$

$$a distance from ( - \frac{{D}_{x}}{2} , - \frac{{D}_{y}}{2} , 0 ) = {d}_{3} = \sqrt{{z}^{′2} + {( {x}^{′} + \frac{{D}_{x}}{2} )}^{2} + {( {y}^{′} + \frac{{D}_{y}}{2} )}^{2}} , and$$

$$a distance from ( \frac{{D}_{x}}{2} , - \frac{{D}_{y}}{2} , 0 ) = {d}_{4} = \sqrt{{z}^{′2} + {( {x}^{′} - \frac{{D}_{x}}{2} )}^{2} + {( {y}^{′} + \frac{{D}_{y}}{2} )}^{2}} .$$

These distance functions are nonlinear difficult to determine and accuracy with respect to estimation error may be difficult and, therefore, direct solutions may be to analyze. Thus, the functions may be linearized by Taylor expansion and application of par-axial approximation, as shown below:

$${d}_{1} - {d}_{2} = \sqrt{{z}^{{′}^{2}} + {( {x}^{′} - \frac{{D}_{x}}{2} )}^{2} + {( {y}^{′} - \frac{{D}_{y}}{2} )}^{2}} - \sqrt{{z}^{{′}^{2}} + {( {x}^{′} + \frac{{D}_{x}}{2} )}^{2} + {( {y}^{′} - \frac{{D}_{y}}{2} )}^{2}} \approx {z}^{′} + \frac{{( {x}^{′} - \frac{{D}_{x}}{2} )}^{2} + {( {y}^{′} - \frac{{D}_{y}}{2} )}^{2}}{2 {z}^{′}} - {z}^{′} - \frac{{( {x}^{′} + \frac{{D}_{x}}{2} )}^{2} + {( {y}^{′} - \frac{{D}_{y}}{2} )}^{2}}{2 {z}^{′}} = - \frac{{x}^{′} {D}_{x}}{{z}^{′}} = - {D}_{x} tan ( {θ}_{x} )$$

Because distance is estimated through phase estimation, n effect, the above operation has kept

$$\frac{{( {x}^{′} + \frac{{D}_{x}}{2} )}^{2}}{λ {z}^{′}} and \frac{{( {y}^{′} - \frac{{D}_{y}}{2} )}^{2}}{λ {z}^{′}}$$

and ignored

$$\frac{{( {x}^{′} + \frac{{D}_{x}}{2} )}^{4}}{λ {z}^{{′}^{3}}} and \frac{{( {y}^{′} + \frac{{D}_{y}}{2} )}^{4}}{λ {z}^{{′}^{3}}} ,$$

as these terms are satisfied by par-axial approximation. In some aspects, an alternative Taylor expansion may include defining r=\sqrt{z′²+x′²+y′²} and using r in the role of z′ above.

To determine beam format, the receiver may perform a solution process by determining:

$${d}_{1} - {d}_{2} \approx - \frac{{x}^{′} {D}_{x}}{{z}^{′}} = - {D}_{x} tan ( {θ}_{x} ) , and \\ {d}_{1} - {d}_{4} \approx - \frac{{y}^{′} {D}_{y}}{{z}^{′}} = - {D}_{y} tan ( {θ}_{y} ) .$$

Based on the discussion above regarding ambiguity removal, the receiver may assume no integer wavelength ambiguity in d₁−d₂ or d₁−d₄. Accordingly, the receiver may solve for tan(Ox) and tan(θy), then input the values of x′=z′ tan(θx) and y′=z′ tan(θy) to d₁−d₃ and solve for z′.

After par-axial approximation, z′ only appears in the denominator in the differential phase/distance. Therefore, the accuracy of z′ may be less than the accuracy associated with tan(θₓ) and tan(θ_{y}). In some aspects, parameters concerning tan(θₓ) and tan(θ_{y}), or and, may be fed back as a whole, and z′ may be fed back individually. Similarly, in some aspects, parameters concerning tan(θₓ) and tan(θ_{y}), or x′/z′ and y′/z′ may result from phase differences across the antenna elements as a linear function of the distance among them (angles of departure). A finite z′ measurement may result in 3D beams with the quadratic terms in the phase. In some aspects, an indication of the accuracy of all of the estimated parameters may be included in the feedback. In some aspects, the receiver may determine the beam format by comparing the estimated distance z′ to a distance threshold.

In some aspects, an alternative Taylor expansion may include defining r=\sqrt{z′²+x′²+y′²} and using r in the role of z′ above. For example, the receiver may determine:

$${d}_{1} = \sqrt{{z}^{′2} + {( {x}^{′} - \frac{{D}_{x}}{2} )}^{2} + {( {y}^{′} - \frac{{D}_{y}}{2} )}^{2}} = \sqrt{{z}^{′2} + {x}^{′2} + {y}^{′2} - {x}^{′} D - {y}^{′} {D}_{x} + \frac{{D}_{x}^{2}}{4} + \frac{{D}_{y}^{2}}{4}} \approx r + \frac{- {x}^{′} {D}_{x} - {y}^{′} {D}_{y} + \frac{{D}_{x}^{2}}{4} + \frac{{D}_{y}^{2}}{4}}{2 r} , {d}_{2} \approx r + \frac{{x}^{′} {D}_{x} - {y}^{′} {D}_{y} + \frac{{D}_{x}^{2}}{4} + \frac{{D}_{y}^{2}}{4}}{2 r} , {d}_{3} \approx r + \frac{{x}^{′} {D}_{x} + {y}^{′} {D}_{y} + \frac{{D}_{x}^{2}}{4} + \frac{{D}_{y}^{2}}{4}}{2 r} , and {d}_{4} \approx r + \frac{- {x}^{′} {D}_{x} + {y}^{′} {D}_{y} + \frac{{D}_{x}^{2}}{4} + \frac{{D}_{y}^{2}}{4}}{2 r} .$$

The approximation may also be based on par-axial condition by assuming that

$$\frac{{( {xx}^{′} )}^{2}}{λ {r}^{3}} << 1 , \frac{{x}^{4}}{λ {r}^{3}} << 1.$$

In some aspects,

$$sin {θ}_{x} = \frac{{x}^{′}}{r}$$

may be non-negligible to allow wide angular coverage and x˜1, so

$$\frac{{x}^{2}}{λ r} << 1$$

may be satisfied. In some aspects, the feedback indication may indicate the values of sin(θₓ) and sin(θ_{y}), or x′/r and y′/r, and the value of r may be fed back as a separate parameter. The accuracy of all the estimated parameters may be included in the feedback. In some aspects, the receiver may determine the beam format based on a threshold on the estimated r.

As indicated above, FIG. 6 is provided as an example. Other examples may differ from what is described with respect to FIG. 6.

FIG. 7 is a diagram illustrating another example 700 of a holographic MIMO model used for beam format detection in holographic MIMO systems, in accordance with the present disclosure. As shown in FIG. 7, a transmit antenna panel 705 may include a number of transmit antenna elements, shown as circles. The transmit antenna panel 705 may include a subset of transmit antenna panel elements (shown as open circles) to be used to transmit reference signals. The transmit antenna panel 705 may be, or be similar to, a transmit antenna panel of the transmitter 510 shown in FIG. 5 and/or the transmitter 415 shown in FIG. 4. Although the description below describes operations of a receiver having (or using) a single antenna element (represented by the circle at coordinate (x′, y′, z′) and which may be, or be similar to, the receiver 505 shown in FIG. 5 and/or the receiver 410 shown in FIG. 4), the concepts described below may alternatively and similarly apply to operations of a receiver having (or using) a plurality of antenna elements receiving reference signals transmitted by a single transmit antenna elements.

In cases in which the transmit antenna element arrangement is as shown in FIG. 7, the receiver may determine that a phase of a reference signal from (0,0,0)—a phase of a reference signal from

$$( x , 0 , 0 ) = \frac{2 π}{λ} \sqrt{{z}^{′2} + {x}^{′2} + {y}^{′2}} - \frac{2 π}{λ} \sqrt{{z}^{′2} + {( {x}^{′} - x )}^{2} + {{y}^{′}}^{2}} .$$

If r=\sqrt{z′²+x′²+y′²}, then the phase of the reference signal from (0,0,0)—the phase of the reference signal from

$$( x , 0 , 0 ) = \frac{2 π}{λ} ( r - \sqrt{{z}^{′2} + {( {x}^{′} - x )}^{2} + {y}^{′2}} ) = \frac{2 π}{λ} ( r - \sqrt{{{r}^{2}}^{} - 2 {xx}^{′} + {x}^{2}} ) \approx \frac{2 π}{λ} ( \frac{{xx}^{′}}{r} - \frac{{x}^{2}}{2 r} ) .$$

In some aspects, the receiver may determine that the phase of the reference signal from (0,0,0)—the phase of the reference signal from

$$( x , 0 , 0 ) \approx \frac{2 π}{λ} ( \frac{{xx}^{′}}{r} - \frac{{x}^{2}}{2 r} ) ,$$

where

$$sin {θ}_{x} = \frac{{x}^{′}}{r}$$

may be non-negligible. To mitigate phase ambiguity, the receiver may use multi-frequency reference signal and phase estimation and/or the distance between the adjacent transmitters may be less than the wavelength λ.

In some aspects, the receiver may determine whether the receiver is located in a far field of the transmitter. For example, in cases in which the transmitter antenna panel is arranged as shown in FIG. 7, the receiver may identify whether it is in the far-field region (z′ or r very large) by determining that the phase of the reference signal from (0,0,0)—the phase of the reference signal from

$$( x , 0 , 0 ) \approx \frac{2 π}{λ} ( \frac{{xx}^{′}}{r} - \frac{{x}^{2}}{2 r} ) .$$

The receiver may run a linear regression of the phase difference against x and x² and determine that if a confidence interval of the slope of x² does not contain 0, the receiver is in the near field. The receiver may continue to calculate y′ and z′ from r and identify a spherical wave converging to (x′,y′,z′). In this case, the phase for a transmitter at (x,y,0) may be determined to be

$$exp [ - \frac{i 2 π [ {( x - {x}^{′} )}^{2} + {( y - {y}^{′} )}^{2} ]}{2 λ {z}^{′}} ] ,$$

if the confidence interval of the slope of x² contains 0, the receiver is in the far field. In that case, the receiver may obtain an estimation of (θₓ,θ_{y}) with

$$sin {θ}_{x} = \frac{{x}^{′}}{r} and sin {θ}_{y} = \frac{{y}^{′}}{r} ,$$

forming a plane wave to the estimated direction, and may determine that the phase for a transmitter at (x,y,0) is given by

$$exp [ - \frac{i π}{λ} ( x sin {θ}_{x} + y sin {θ}_{y} ) ] .$$

In some aspects, the receiver may use a regression-type estimation of differential distance. For example, the distance may be calculated based on observed phase and phase difference:

$${φ}_{1} ( {f}_{1} ) - {φ}_{2} ( {f}_{1} ) + ( {m}_{1 , {f}_{1}} - {m}_{2 , {f}_{1}} ) ( 2 π ) = \frac{2 {πf}_{1}}{c} ( {d}_{1} - {d}_{2} ) ,$$

where phase difference is frequency dependent and phase difference at multiple frequencies may be combined to calculate differential distance. In some aspects, the linear-regression type of algorithm can be used to utilize measurement at all sub-carriers with reference signal.

As indicated above, FIG. 7 is provided as an example. Other examples may differ from what is described with respect to FIG. 7.

FIG. 8 is a diagram illustrating an example process 800 performed, for example, by a receiver, in accordance with the present disclosure. Example process 800 is an example where the receiver (e.g., receiver 505 depicted in FIG. 5) performs operations associated with beam format detection in holographic MIMO systems.

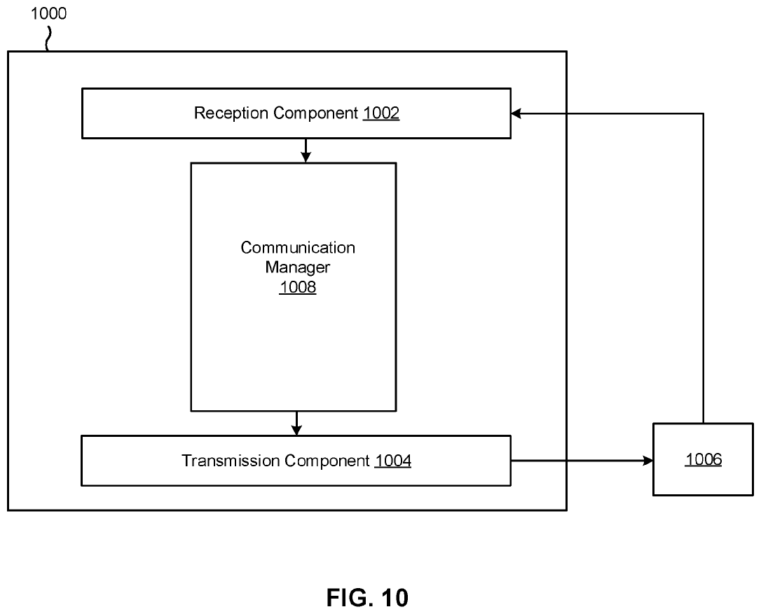

As shown in FIG. 8, in some aspects, process 800 may include receiving, using at least one receive antenna element, a plurality of reference signals associated with at least one transmit antenna element of a transmitter of the holographic MIMO communication (block 810). For example, the receiver (e.g., using communication manager 1008 and/or reception component 1002, depicted in FIG. 10) may receive, using at least one receive antenna element, a plurality of reference signals associated with at least one transmit antenna element of a transmitter of the holographic MIMO communication, as described above.

As further shown in FIG. 8, in some aspects, process 800 may include communicating using two-dimensional beams or three-dimensional beams based at least in part on a determination of a beam format associated with the plurality of reference signals (block 820). For example, the receiver (e.g., using communication manager 1008, reception component 1002, and/or transmission component 1004, depicted in FIG. 10) may communicate using two-dimensional beams or three-dimensional beams based at least in part on a determination of a beam format associated with the plurality of reference signals, as described above.

Process 800 may include additional aspects, such as any single aspect or any combination of aspects described below and/or in connection with one or more other processes described elsewhere herein.

In a first aspect, the at least one receive antenna element comprises only a single receive antenna element, and the at least one transmit antenna element comprises a plurality of transmit antenna elements.

In a second aspect, alone or in combination with the first aspect, the plurality of transmit antenna elements comprises a first transmit antenna element associated with a first axis of a reference coordinate system corresponding to a transmit antenna panel and a second transmit antenna element associated with a second axis of the reference coordinate system, wherein the first and second axes are perpendicular to one another and correspond to a plane in which the transmit antenna panel lies.

In a third aspect, alone or in combination with one or more of the first and second aspects, the first transmit antenna element is located at a first corner of the transmit antenna panel, the second transmit antenna element is located at a second corner of the transmit antenna panel, a third transmit antenna element of the plurality of transmit antenna elements is located at a third corner of the transmit antenna panel, and a fourth transmit antenna element of the plurality of transmit antenna elements is located at a fourth corner of the transmit antenna panel.

In a fourth aspect, alone or in combination with one or more of the first through third aspects, the first transmit antenna element is located on the first axis of the reference coordinate system, and the second transmit antenna element is located on the second axis of the reference coordinate system.

In a fifth aspect, alone or in combination with one or more of the first through fourth aspects, each of the plurality of transmit antenna elements is individually identifiable to the receiver.

In a sixth aspect, alone or in combination with one or more of the first through fifth aspects, each of the plurality of transmit antenna elements corresponds to a respective cyclic shift of a sequence used to generate a respective reference signal of the plurality of reference signals.

In a seventh aspect, alone or in combination with one or more of the first through sixth aspects, process 800 includes measuring a phase difference across the plurality of transmit antenna elements, and determining the beam format based at least in part on the phase difference.

In an eighth aspect, alone or in combination with one or more of the first through seventh aspects, determining the beam format comprises determining the beam format based at least in part on at least one of a quadratic expansion procedure, a Taylor expansion procedure, or a regression-type estimation procedure.

In a ninth aspect, alone or in combination with one or more of the first through eighth aspects, the plurality of reference signals are generated from a common phase reference source.

In a tenth aspect, alone or in combination with one or more of the first through ninth aspects, the plurality of transmit antenna elements each is associated with a first maximum transmit power, wherein at least one unused transmit antenna element is associated with a second maximum transmit power that is different than the first maximum transmit power.

In an eleventh aspect, alone or in combination with one or morm of the first through tenth aspects, the at least one receive antenna element comprises a plurality of receive antenna elements, and the at least one transmit antenna element comprises only a single transmit antenna element.

In a twelfth aspect, alone or in combination with one or more of the first through eleventh aspects, the plurality of receive antenna elements comprises a first receive antenna element associated with a first axis of a reference coordinate system corresponding to a receive antenna panel and a second receive antenna element associated with a second axis of the reference coordinate system, wherein the first and second axes are perpendicular to one another and correspond to a plane in which the receive antenna panel lies.

In a thirteenth aspect, alone or in combination with one or more of the first through twelfth aspects, the first receive antenna element is located at a first corner of the receive antenna panel, the second receive antenna element is located at a second corner of the receive antenna panel, a third receive antenna element of the plurality of receive antenna elements is located at a third corner of the receive antenna panel, and a fourth receive antenna element of the plurality of receive antenna elements is located at a fourth corner of the receive antenna panel.

In a fourteenth aspect, alone or in combination with one or more of the first through thirteenth aspects, the first receive antenna element is located on the first axis of the reference coordinate system, and the second receive antenna element is located on the second axis of the reference coordinate system.

In a fifteenth aspect, alone or in combination with one or more of the first through fourteenth aspects, the plurality of receive antennas use a common phase reference source.

In a sixteenth aspect, alone or in combination with one or more of the first through fifteenth aspects, process 800 includes measuring a phase difference across the plurality of receive antenna elements, and determining the beam format based at least in part on the phase difference.

In a seventeenth aspect, alone or in combination with one or more of the first through sixteenth aspects, each reference signal of the plurality of reference signals comprises a frequency domain density that satisfies a density threshold.

In an eighteenth aspect, alone or in combination with one or more of the first through seventeenth aspects, a distance between two adjacent transmit antenna elements is less than half of a wavelength or a distance between two adjacent receive antenna elements is less than half of a wavelength.

In a nineteenth aspect, alone or in combination with one or more of the first through eighteenth aspects, process 800 includes removing phase ambiguity associated with the plurality of reference signals based at least in part on using a plurality of sub-carriers for each reference signal of the plurality of reference signals.

In a twentieth aspect, alone or in combination with one or more of the first through nineteenth aspects, each reference signal of the plurality of reference signals spans an available bandwidth.

In a twenty-first aspect, alone or in combination with one or more of the first through twentieth aspects, process 800 includes transmitting a feedback indication that indicates at least one of a plurality of carrier phase measurements corresponding to the plurality of reference signals, or a position measurement parameter corresponding to the receiver with respect to an antenna panel of the transmitter.

In a twenty-second aspect, alone or in combination with one or more of the first through twenty-first aspects, the feedback indication includes an accuracy indication associated with the position measurement parameter.

In a twenty-third aspect, alone or in combination with one or more of the first through twenty-second aspects, transmitting the feedback indication comprises transmitting at least one of a radio resource control message, a medium access control control element, or a physical layer signal.

In a twenty-fourth aspect, alone or in combination with one or more of the first through twenty-third aspects, process 800 includes determining that the receiver is within a far-field region with respect to the transmitter based at least in part on one or more phase difference measurements associated with the plurality of reference signals.

In a twenty-fifth aspect, alone or in combination with one or more of the first through twenty-fourth aspects, process 800 includes determining the beam format during a positioning procedure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a transmitter, in accordance with the present disclosure. Example process 900 is an example where the transmitter (e.g., transmitter 510 depicted in FIG. 5) performs operations associated with beam format detection in holographic MIMO systems.

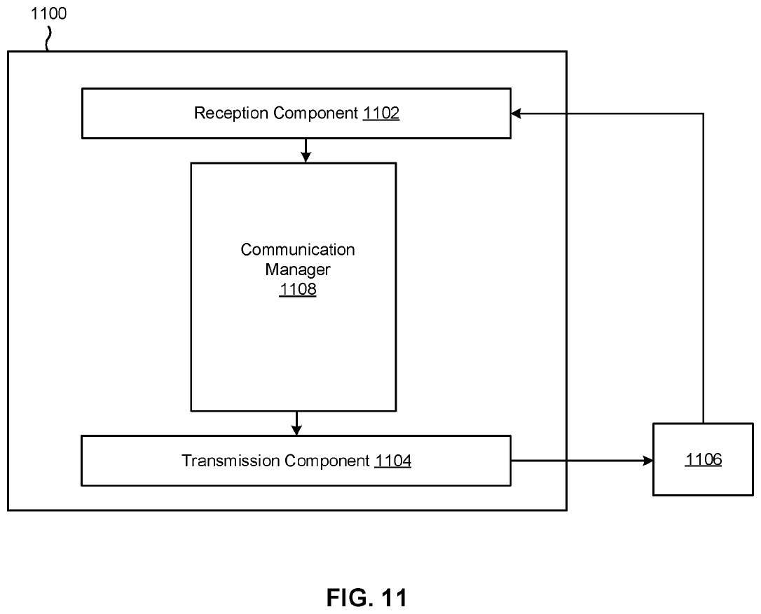

As shown in FIG. 9, in some aspects, process 900 may include transmitting, to a receiver of the holographic MIMO communication that includes at least one receive antenna element, a plurality of reference signals associated with at least one transmit antenna element of the transmitter (block 910). For example, the transmitter (e.g., using communication manager 1108 and/or transmission component 1104, depicted in FIG. 11) may transmit, to a receiver of the holographic MIMO communication that includes at least one receive antenna element, a plurality of reference signals associated with at least one transmit antenna element of the transmitter, as described above.

As further shown in FIG. 9, in some aspects, process 900 may include receiving a feedback indication based at least in part on a determination of a beam format associated with the plurality of reference signals (block 920). For example, the transmitter (e.g., using communication manager 1108 and/or reception component 1102, depicted in FIG. 11) may receive a feedback indication based at least in part on a determination of a beam format associated with the plurality of reference signals, as described above.

Process 900 may include additional aspects, such as any single aspect or any combination of aspects described below and/or in connection with one or more other processes described elsewhere herein.

In a first aspect, the feedback indication indicates at least one of a plurality of carrier phase measurements corresponding to the plurality of reference signals, or a position measurement parameter corresponding to the receiver with respect to an antenna panel of the transmitter.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a receiver, or a receiver may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the receiver described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE and/or the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE and/or the base station described in connection with FIG. 2. In some aspects, the transmission component 1004 may be co-located with the reception component 1002 in a transceiver.

The reception component 1002 may receive, using at least one receive antenna element, a plurality of reference signals associated with at least one transmit antenna element of a transmitter of the holographic MIMO communication. The communication manager 1008, the reception component 1002, and/or the transmission component 1004 may communicate using two-dimensional beams or three-dimensional beams based at least in part on a determination of a beam format associated with the plurality of reference signals. In some aspects, the communication manager 1008 may include one or more antennas, a modem, a modulator, a transmit MIMO processor, a transmit processor, a controller/processor, a memory, or a combination thereof, of the UE and/or the base station described in connection with FIG. 2. In some aspects, the communication manager 1008 may include the reception component 1002 and/or the transmission component 1004.

The communication manager 1008 may measure a phase difference across the plurality of transmit antenna elements. The communication manager 1008 may determine the beam format based at least in part on the phase difference. The communication manager 1008 may measure a phase difference across the plurality of receive antenna elements. The communication manager 1008 may determine the beam format based at least in part on the phase difference.

The communication manager 1008 may remove phase ambiguity associated with the plurality of reference signals based at least in part on using a plurality of sub-carriers for each reference signal of the plurality of reference signals.

The transmission component 1004 may transmit a feedback indication that indicates at least one of a plurality of carrier phase measurements corresponding to the plurality of reference signals, or a position measurement parameter corresponding to the receiver with respect to an antenna panel of the transmitter.

The communication manager 1008 may determine that the receiver is within a far-field region with respect to the transmitter based at least in part on one or more phase difference measurements associated with the plurality of reference signals.

The communication manager 1008 may determine the beam format during a positioning procedure.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a transmitter, or a transmitter may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the transmitter described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE and/or the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE and/or the base station described in connection with FIG. 2. In some aspects, the transmission component 1104 may be co-located with the reception component 1102 in a transceiver.

The communication manager 1108 and/or the transmission component 1104 may transmit, to a receiver of the holographic MIMO communication that includes at least one receive antenna element, a plurality of reference signals associated with at least one transmit antenna element of the transmitter. The reception component 1102 may receive a feedback indication based at least in part on a determination of a beam format associated with the plurality of reference signals. In some aspects, the communication manager 1108 may include one or more antennas, a modem, a modulator, a transmit MIMO processor, a transmit processor, a controller/processor, a memory, or a combination thereof, of the UE and/or the base station described in connection with FIG. 2. In some aspects, the communication manager 1108 may include the reception component 1102 and/or the transmission component 1104.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a receiver of a holographic multiple input multiple output (MIMO) communication, comprising: receiving, using at least one receive antenna element, a plurality of reference signals associated with at least one transmit antenna element of a transmitter of the holographic MIMO communication; and communicating using two-dimensional beams or three-dimensional beams based at least in part on a determination of a beam format associated with the plurality of reference signals.

Aspect 2: The method of Aspect 1, wherein the at least one receive antenna element comprises only a single receive antenna element and wherein the at least one transmit antenna element comprises a plurality of transmit antenna elements.

Aspect 3: The method of Aspect 2, wherein the plurality of transmit antenna elements comprises a first transmit antenna element associated with a first axis of a reference coordinate system corresponding to a transmit antenna panel and a second transmit antenna element associated with a second axis of the reference coordinate system, wherein the first and second axes are perpendicular to one another and correspond to a plane in which the transmit antenna panel lies.

Aspect 4: The method of Aspect 3, wherein the first transmit antenna element is located at a first corner of the transmit antenna panel, the second transmit antenna element is located at a second corner of the transmit antenna panel, a third transmit antenna element of the plurality of transmit antenna elements is located at a third corner of the transmit antenna panel, and a fourth transmit antenna element of the plurality of transmit antenna elements is located at a fourth corner of the transmit antenna panel.

Aspect 5: The method of Aspect 3, wherein the first transmit antenna element is located on the first axis of the reference coordinate system, and wherein the second transmit antenna element is located on the second axis of the reference coordinate system.

Aspect 6: The method of any of Aspects 2-5, wherein each of the plurality of transmit antenna elements is individually identifiable to the receiver.

Aspect 7: The method of Aspect 6, wherein each of the plurality of transmit antenna elements corresponds to a respective cyclic shift of a sequence used to generate a respective reference signal of the plurality of reference signals.

Aspect 8: The method of any of Aspects 2-7, further comprising: measuring a phase difference across the plurality of transmit antenna elements; and determining the beam format based at least in part on the phase difference.

Aspect 9: The method of Aspect 8, wherein determining the beam format comprises determining the beam format based at least in part on at least one of a quadratic expansion procedure, a Taylor expansion procedure, or a regression-type estimation procedure.

Aspect 10: The method of any of Aspects 2-9, wherein the plurality of reference signals are generated from a common phase reference source.

Aspect 11: The method of any of Aspects 2-10, wherein the plurality of transmit antenna elements each is associated with a first maximum transmit power, wherein at least one unused transmit antenna element is associated with a second maximum transmit power that is different than the first maximum transmit power.

Aspect 12: The method of Aspect 1, wherein the at least one receive antenna element comprises a plurality of receive antenna elements and wherein the at least one transmit antenna element comprises only a single transmit antenna element.

Aspect 13: The method of Aspect 12, wherein the plurality of receive antenna elements comprises a first receive antenna element associated with a first axis of a reference coordinate system corresponding to a receive antenna panel and a second receive antenna element associated with a second axis of the reference coordinate system, wherein the first and second axes are perpendicular to one another and correspond to a plane in which the receive antenna panel lies.

Aspect 14: The method of Aspect 13, wherein the first receive antenna element is located at a first corner of the receive antenna panel, the second receive antenna element is located at a second corner of the receive antenna panel, a third receive antenna element of the plurality of receive antenna elements is located at a third corner of the receive antenna panel, and a fourth receive antenna element of the plurality of receive antenna elements is located at a fourth corner of the receive antenna panel.

Aspect 15: The method of Aspect 13, wherein the first receive antenna element is located on the first axis of the reference coordinate system, and wherein the second receive antenna element is located on the second axis of the reference coordinate system.

Aspect 16: The method of any of Aspects 12-15, wherein the plurality of receive antennas use a common phase reference source.

Aspect 17: The method of any of Aspects 12-16, further comprising: measuring a phase difference across the plurality of receive antenna elements; and determining the beam format based at least in part on the phase difference.

Aspect 18: The method of any of Aspects 1-17, wherein each reference signal of the plurality of reference signals comprises a frequency domain density that satisfies a density threshold.

Aspect 19: The method of any of Aspects 1-18, wherein a distance between two adjacent transmit antenna elements is less than half of a wavelength or a distance between two adjacent receive antenna elements is less than half of a wavelength.

Aspect 20: The method of any of Aspects 1-19, further comprising removing phase ambiguity associated with the plurality of reference signals based at least in part on using a plurality of sub-carriers for each reference signal of the plurality of reference signals.

Aspect 21: The method of any of Aspects 1-20, wherein each reference signal of the plurality of reference signals spans an available bandwidth.

Aspect 22: The method of any of Aspects 1-21, further comprising transmitting a feedback indication that indicates at least one of: a plurality of carrier phase measurements corresponding to the plurality of reference signals, or a position measurement parameter corresponding to the receiver with respect to an antenna panel of the transmitter.

Aspect 23: The method of Aspect 22, wherein the feedback indication includes an accuracy indication associated with the position measurement parameter.

Aspect 24: The method of either of Aspects 22 or 23, wherein transmitting the feedback indication comprises transmitting at least one of a radio resource control message, a medium access control control element, or a physical layer signal.

Aspect 25: The method of any of Aspects 1-24, further comprising determining that the receiver is within a far-field region with respect to the transmitter based at least in part on one or more phase difference measurements associated with the plurality of reference signals.

Aspect 26: The method of any of Aspects 1-25, further comprising determining the beam format during a positioning procedure.

Aspect 27: A method of wireless communication performed by a transmitter of a holographic multiple input multiple output (MIMO) communication, comprising: transmitting, to a receiver of the holographic MIMO communication that includes at least one receive antenna element, a plurality of reference signals associated with at least one transmit antenna element of the transmitter; and receiving a feedback indication based at least in part on a determination of a beam format associated with the plurality of reference signals.

Aspect 28: The method of Aspect 27, wherein the feedback indication indicates at least one of: a plurality of carrier phase measurements corresponding to the plurality of reference signals, or a position measurement parameter corresponding to the receiver with respect to an antenna panel of the transmitter.

Aspect 29: An apparatus for wireless communication at a device, comprising a processor; memory coupled with the processor; and instructions stored in the memory and executable by the processor to cause the apparatus to perform the method of one or more of Aspects 1-26.

Aspect 30: A device for wireless communication, comprising a memory and one or more processors coupled to the memory, the one or more processors configured to perform the method of one or more of Aspects 1-26.

Aspect 31: An apparatus for wireless communication, comprising at least one means for performing the method of one or more of Aspects 1-26.

Aspect 32: A non-transitory computer-readable medium storing code for wireless communication, the code comprising instructions executable by a processor to perform the method of one or more of Aspects 1-26.

Aspect 33: A non-transitory computer-readable medium storing a set of instructions for wireless communication, the set of instructions comprising one or more instructions that, when executed by one or more processors of a device, cause the device to perform the method of one or more of Aspects 1-26.

Aspect 34: An apparatus for wireless communication at a device, comprising a processor; memory coupled with the processor; and instructions stored in the memory and executable by the processor to cause the apparatus to perform the method of one or more of Aspects 27-28.

Aspect 35: A device for wireless communication, comprising a memory and one or more processors coupled to the memory, the one or more processors configured to perform the method of one or more of Aspects 27-28.

Aspect 36: An apparatus for wireless communication, comprising at least one means for performing the method of one or more of Aspects 27-28.

Aspect 37: A non-transitory computer-readable medium storing code for wireless communication, the code comprising instructions executable by a processor to perform the method of one or more of Aspects 27-28.

Aspect 38: A non-transitory computer-readable medium storing a set of instructions for wireless communication, the set of instructions comprising one or more instructions that, when executed by one or more processors of a device, cause the device to perform the method of one or more of Aspects 27-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A receiver of a holographic multiple input multiple output (MIMO) communication, comprising:
a memory; and
one or more processors, coupled to the memory, configured to:
receive, using at least one receive antenna element, a plurality of reference signals associated with at least one transmit antenna element of a transmitter of the holographic MIMO communication; and
communicate using two-dimensional beams or three-dimensional beams based at least in part on a determination of abeam format associated with the plurality of reference signals.

2. The receiver of claim 1, wherein the at least one receive antenna element comprises only a single receive antenna element and wherein the at least one transmit antenna element comprises a plurality of transmit antenna elements.

3. The receiver of claim 2, wherein the plurality of transmit antenna elements comprises a first transmit antenna element associated with a first axis of a reference coordinate system corresponding to a transmit antenna panel and a second transmit antenna element associated with a second axis of the reference coordinate system, wherein the first and second axes are perpendicular to one another and correspond to a plane in which the transmit antenna panel lies.

4. The receiver of claim 3, wherein the first transmit antenna element is located at a first corner of the transmit antenna panel, the second transmit antenna element is located at a second corner of the transmit antenna panel, a third transmit antenna element of the plurality of transmit antenna elements is located at a third corner of the transmit antenna panel, and a fourth transmit antenna element of the plurality of transmit antenna elements is located at a fourth corner of the transmit antenna panel.

5. The receiver of claim 3, wherein the first transmit antenna element is located on the first axis of the reference coordinate system, and wherein the second transmit antenna element is located on the second axis of the reference coordinate system.

6. The receiver of claim 2, wherein each of the plurality of transmit antenna elements is individually identifiable to the receiver, and wherein each of the plurality of transmit antenna elements corresponds to a respective cyclic shift of a sequence used to generate a respective reference signal of the plurality of reference signals.

7. The receiver of claim 2, wherein the one or more processors are further configured to:
measure a phase difference across the plurality of transmit antenna elements; and
determine the beam format based at least in part on the phase difference.

8. The receiver of claim 7, wherein the one or more processors, to determine the beam format, are configured to determine the beam format based at least in part on at least one of a quadratic expansion procedure, a Taylor expansion procedure, or a regression-type estimation procedure.

9. The receiver of claim 2, wherein the plurality of reference signals are generated from a common phase reference source.

10. The receiver of claim 2, wherein the plurality of transmit antenna elements each is associated with a first maximum transmit power, wherein at least one unused transmit antenna element is associated with a second maximum transmit power that is different than the first maximum transmit power.

11. The receiver of claim 1, wherein the at least one receive antenna element comprises a plurality of receive antenna elements and wherein the at least one transmit antenna element comprises only a single transmit antenna element.

12. The receiver of claim 11, wherein the plurality of receive antenna elements comprises a first receive antenna element associated with a first axis of a reference coordinate system corresponding to a receive antenna panel and a second receive antenna element associated with a second axis of the reference coordinate system, wherein the first and second axes are perpendicular to one another and correspond to a plane in which the receive antenna panel lies.

13. The receiver of claim 12, wherein the first receive antenna element is located at a first corner of the receive antenna panel, the second receive antenna element is located at a second corner of the receive antenna panel, a third receive antenna element of the plurality of receive antenna elements is located at a third corner of the receive antenna panel, and a fourth receive antenna element of the plurality of receive antenna elements is located at a fourth corner of the receive antenna panel.

14. The receiver of claim 12, wherein the first receive antenna element is located on the first axis of the reference coordinate system, and wherein the second receive antenna element is located on the second axis of the reference coordinate system.

15. The receiver of claim 11, wherein the plurality of receive antennas use a common phase reference source.

16. The receiver of claim 11, wherein the one or more processors are further configured to:
measure a phase difference across the plurality of receive antenna elements; and
determine the beam format based at least in part on the phase difference.

17. The receiver of claim 1, wherein each reference signal of the plurality of reference signals comprises a frequency domain density that satisfies a density threshold.

18. The receiver of claim 1, wherein a distance between two adjacent transmit antenna elements is less than half of a wavelength or a distance between two adjacent receive antenna elements is less than half of a wavelength.

19. The receiver of claim 1, wherein the one or more processors are further configured to remove phase ambiguity associated with the plurality of reference signals based at least in part on using a plurality of sub-carriers for each reference signal of the plurality of reference signals.

20. The receiver of claim 1, wherein each reference signal of the plurality of reference signals spans an available bandwidth.

21. The receiver of claim 1, wherein the one or more processors are further configured to transmit a feedback indication that indicates at least one of:
a plurality of carrier phase measurements corresponding to the plurality of reference signals, or
a position measurement parameter corresponding to the receiver with respect to an antenna panel of the transmitter.

22. The receiver of claim 21, wherein the feedback indication includes an accuracy indication associated with the position measurement parameter.

23. The receiver of claim 1, wherein the one or more processors are further configured to determine that the receiver is within a far-field region with respect to the transmitter based at least in part on one or more phase difference measurements associated with the plurality of reference signals.

24. The receiver of claim 1, wherein the one or more processors are further configured to determine the beam format during a positioning procedure.

25. A transmitter of a holographic multiple input multiple output (MIMO), comprising:
a memory; and
one or more processors, coupled to the memory, configured to:
transmit, to a receiver of the holographic MIMO communication that includes at least one receive antenna element, a plurality of reference signals associated with at least one transmit antenna element of the transmitter; and
receive a feedback indication based at least in part on a determination of a beam format associated with the plurality of reference signals.

26. The transmitter of claim 25, wherein the feedback indication indicates at least one of:
a plurality of carrier phase measurements corresponding to the plurality of reference signals, or
a position measurement parameter corresponding to the receiver with respect to an antenna panel of the transmitter.

27. A method of wireless communication performed by a receiver of a holographic multiple input multiple output (MIMO) communication, comprising:
receiving, using at least one receive antenna element, a plurality of reference signals associated with at least one transmit antenna element of a transmitter of the holographic MIMO communication; and
communicating using two-dimensional beams or three-dimensional beams based at least in part on a determination of a beam format associated with the plurality of reference signals.

28. The method of claim 27, wherein the at least one receive antenna element comprises only a single receive antenna element and wherein the at least one transmit antenna element comprises a plurality of transmit antenna elements, or wherein the at least one receive antenna element comprises a plurality of receive antenna elements and wherein the at least one transmit antenna element comprises only a single transmit antenna element.

29. A method of wireless communication performed by a transmitter of a holographic multiple input multiple output (MIMO) communication, comprising:
transmitting, to a receiver of the holographic MIMO communication that includes at least one receive antenna element, a plurality of reference signals associated with at least one transmit antenna element of the transmitter; and
receiving a feedback indication based at least in part on a determination of a beam format associated with the plurality of reference signals.

30. The method of claim 29, wherein the feedback indication indicates at least one of:
a plurality of carrier phase measurements corresponding to the plurality of reference signals, or
a position measurement parameter corresponding to the receiver with respect to an antenna panel of the transmitter.
